(19) United States
(12) Patent Application Publication
(10) Pub. No.: US 2002/0124236 A1
(43) Pub. Date: Sep. 5, 2002

(54) Method of manipulating a distributed system of computer-implemented objects

(76) Inventors: Derek Augustus Samuel Ruths, Houston, TX (US); Jefferson David Hoye, Houston, TX (US)

Correspondence Address: ROGER FULGHUM, BAKER BOTTS L.L.P., 910 LOUISIANA, ONE SHELL PLAZA, HOUSTON, TX, 77002, US

(21) Appl. No.: 09/749,203

(22) Filed: Dec. 27, 2000

(51) Int. Cl. G06F 9/44

(52) U.S. Cl. 717/104; 717/108

(57) ABSTRACT

A technique for manipulating computer-implemented objects uses a Command-Behavior technique to separate Behaviors, which perform actions on the object, from Commands, which cause the Behaviors to be invoked. A dynamic mapping of Commands to Behaviors allows the system to change which Behavior is invoked by a Command. Objects in the system can have Shadows, the Shadows and the object communicating with each other. The technique allows objects and their Shadows to transparently reside anywhere in a distributed network of servers, using any available network protocol for communication.

### STATEMENT REGARDING FEDERALLY SPONSORED RESEARCH

The U.S. Government has a paid-up license in this invention and the right in limited circumstances to require the patent owner to license others on reasonable terms as provided for by the terms of Grant No. EIA-9975020 awarded by the National Science Foundation.

### CROSS-REFERENCE TO RELATED APPLICATIONS

Not applicable.

### BACKGROUND OF THE INVENTION

1. Field of the Invention

The present invention relates to a technique for manipulating computer-implemented objects and particularly for an object-oriented technique for manipulating computer-implemented objects in a distributed system.

2. Description of the Related Art

Internet technologies have brought about a fundamental change in the way computer applications are designed and displayed. Typical visualization applications have moved from low-level, platform dependent applications carefully crafted to take the fullest possible advantage of limited hardware resources, to applications intended for fast development on highly capable fast hardware. But techniques for manipulating objects in networked environments remain complex.

Historically, 3D graphics programmers have needed to wring every last ounce of performance from their graphics hardware in order to obtain a high degree of visual realism. Developers have often had to leverage extensive knowledge of underlying hardware details in order to obtain maximum performance from a given graphics accelerator. Even as hardware performance improvements have made detailed hardware knowledge less critical, graphics programming has remained complex.

Cross-platform applications programming interfaces (APIs) such as Silicon Graphics, Inc.'s Open GL, have been developed to allow programmers to use similar techniques on multiple platforms, providing an abstract representation of the hardware in the API. However, these low-level APIs have required a high degree of programming expertise in order to exact optimized performance from different hardware platforms. These realities have resulted in a difficult and expensive development process that has often mandated platform-specific development efforts, leaving fewer resources to focus on application functionality.

Although higher-level tool kits and file formats such as the Virtual Reality Modeling Language (VRML) have been developed to ease this process somewhat, networked manipulation of computer-implemented objects remains complex.

A typical visualization application requires creating a framework that allows interaction of a specified set of input and output devices with the virtual objects. These devices can range from a keyboard and a mouse to simple gaming devices such as a joystick to more elaborate devices such as the Immersadesk (IDesk) from Fakespace, Inc., head mounted displays (HMDs) and head trackers, which track the movement of the head of the wearer. A scene graph model is frequently used to represent and render potentially complex 3D environments. The scene graph usually contains a complete description of the entire scene, or virtual universe. This usually includes geometric data, attribute information, and viewing information needed to render the scene from a particular point of view. JAVA3D, an attempt at a high-level 3D API that tries to provide a high degree of interactivity while preserving platform independence, uses a scene graph programming model to manage a virtual universe.

Numerous current tool kits exist. Among these toolkits are Silicon Graphics' SGI Performer, SGI Inventor, and SGI Open GL; Microsoft Corporation's DirectX; VRCO, Inc.'s Cavelib; CavernSoft from the Electronic Visualization Laboratory of the University of Illinois at Chicago; VRJuggler from the University of Iowa; and VEGA from the University of Hull. Although each of these tool kits has advantages and disadvantages, these toolkits are relatively low-level, platform-dependent, and networking is cumbersome. In addition, the Common Object Request Broker Architecture (CORBA) of the Object Management Group and the Common Object Model (COM) of Microsoft Corporation provide object brokers, but are not graphics oriented or performance optimized and do not assist the programmer in managing the shared environment.

Most graphics development tools require a significant investment in coding overhead and produce platform dependent, highly inflexible and inextensible applications. Sun Microsystems JAVA3D attempts to provide a platform independent API that yields a high degree of interactivity in a high level, object-oriented paradigm. However, the coding overhead and complexity of the scene graph model still often hinder rapid development. For example, in JAVA3D, the scene graph is separated from code for the object Behaviors. Where all of the attributes for an object do not reside within one entity, distributed systems can be difficult to create.

The computer community has needed a standard platform which supports rapid development of portable, hardware independent, distributed, collaborative applications.

### SUMMARY OF THE INVENTION

Briefly, a system for manipulating computer-implemented objects in a distributed system provides software for creating a shared environment of multiple objects. Each of the objects in the shared environment has a number of Behaviors, executing Behaviors responsive to a Command. A Command-Behavior mapping is used to map Commands received by the object to Behaviors, executing a selected Behavior responsive to the Command.

In one embodiment, the Behaviors and the Command-Behavior mapping are private to the object. A default Behavior is executed in a further embodiment if no Behavior is mapped to the Command.

Another embodiment provides for creating Shadows of the object, which are synchronized with the object. The Shadows can have a different Command-Behavior mapping from the object. In one embodiment, a plurality of Shadows can be created for an object, all of which communicate with each other to synchronize the Shadows and the objects. A Shadow can be promoted into a new object, and in one embodiment, promoting a Shadow into a new object converts the other Shadows of the original object into Shadows of the new object.

The distributed system can reside on multiple servers, and in one embodiment code to manage the servers can promote a Shadow of an object to a new object if the server on which the object resides experiences a predetermined condition.

In one embodiment, the software provides code to modify the Command-Behavior mapping of an object. The Command-Behavior mapping can be created from an external data source.

In a multiple server embodiment, the object is located on one of the servers, and acts independently of its location. In a further embodiment, the software can use any available networking protocol to communicate between objects.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram of a single shared environment according to one embodiment;

FIG. 2a is a block diagram of a multiple shared environment distributed system S;

FIG. 2b is a block diagram illustrating transparent networking aspects of a multiple server distributed system S according to one embodiment;

FIG. 3 is a block diagram of an exemplary Pawn according to one embodiment;

FIGS. 4a, 4b, and 4c are illustrations of exemplary mappings between Commands and Behaviors;

FIG. 5 is a block diagram illustrating the interaction between Pawns and Shadows in a distributed system according to one embodiment;

FIG. 5b is a graph illustrating the use of Nodes for Pawn-Shadow interaction in a distributed system according the one embodiment;

FIG. 6 is a flowchart illustrating the steps of using a key to authenticate access to a Pawn;

FIG. 7 is a flowchart of receiving and executing a Command; and

FIG. 8 is a flowchart illustrating creating a Pawn in both local and remote environments.

### DETAILED DESCRIPTION OF INVENTION

Introduction

An embodiment as disclosed addresses many issues in current graphics application design. In doing so, it offers rapid development, transparent networking, hardware independence, and modular design benefits.

Architectural Overview

Before proceeding further, a brief introduction into the various elements and terms used in a system according to a disclosed embodiment would be useful. Although certain terms such as “Kernel” are familiar to one skilled in the computing arts, and in particular in the object-oriented programming arts, these terms may have specialized uses in the disclosed embodiments.

Distributed System

A distributed system according to a disclosed embodiment is a collection of servers, each of which is running a shared environment. The distributed system is organized in a peer-to-peer fashion, rather than in a client-server fashion. Each shared environment in the distributed system communicates with each other shared environment, and each shared environment recognizes the entry into and exit from the distributed system of every other shared environment. When the term “server” is used below, it refers to the computer system on which a shared environment exists.

Shared Environment

A shared environment according to a disclosed embodiment is a run-time object-oriented environment under the control of an operating system on a computer. The shared environment comprises a Kernel, some number of Constructs corresponding to output capabilities of the computer system, some number of ControlDevices corresponding to hardware input devices connected to the computer, and some number of Pawns and Shadows of Pawns, together with their associated Nodes and States as defined below. In one embodiment, the shared environment can contain a Nengine. In a distributed system of multiple shared environments, each shared environment has a Nengine. The object-oriented runtime environment is created by the runtime libraries of an object-oriented programming language, such as the JAVA language, together with objects and classes that support a CommandReceiver paradigm. In a distributed system, shared environments which exist on computer systems other than the one being used by a user are remote shared environments, while the one being used by the user is a local shared environment.

All of the following elements are objects in the object-oriented programming sense. As with conventional object-oriented programming systems, objects are instantiated from classes that define their attributes. Unless otherwise specified, reference to a “method” in this Detailed Description refers to the object-oriented programming concept of a method associated with a class.

CommandReceiver

A CommandReceiver is an object that is capable of receiving Commands and executing Behaviors that have been associated with specific Commands. Unless otherwise specified, all objects described below are CommandReceiver objects, including the Kernel. The CommandReceiver object is the basic building block of the shared environment, linking Commands with Behaviors.

Command

A Command is an object that is the fundamental unit of communication. A single Command represents a single event. Commands may be CommandReceiver objects, but can be other kinds of objects, as well.

Behavior

A Behavior is a method or logic executed by a CommandReceiver in response to a Command. In one embodiment, Behaviors are private methods, not exposed outside of the CommandReceiver object. Commands are mapped to Behaviors via a Command-Behavior mapping. A linking technique dynamically creates and modifies the Command-Behavior mapping. A CommandReceiver sending a Command to another CommandReceiver does not know what Behavior will actually be executed by the receiving CommandReceiver. In one embodiment, CommandReceivers can have a default Behavior that will be executed if the received Command is not mapped to any Behavior. Behaviors are methods of CommandReceiver objects, rather than CommandReceiver objects in themselves.

Kernel

A Kernel is the core of the shared environment. The Kernel object loosely manages all CommandReceivers. The Kernel provides hooks into managing the shared environment, having the power to remove, add, or modify the CommandReceivers in real time. When CommandReceiver objects are created, they are registered with the Kernel.

Console

A Console is a user's interface to the Kernel. Analogous to a Unix Console, it gives the user direct access to the distributed system, allowing the user to create and manipulate objects in the distributed system.

Pawn

A Pawn is a CommandReceiver that is networkable by default, i.e., the Pawn can exist in a networked distributed system of multiple shared environments. Pawns may be either real Pawns or Shadows, as will be described below. Pawns have attributes that characterize the Pawn, such as the Pawn's location in some coordinate frame. Pawns can have subPawns, each of which is a Pawn.

A Pawn may represent other computer-implemented objects or provide computer implementation of physical objects, including simulation of physical objects. For example, a Pawn can be written to represent a submarine for simulation purposes. Likewise, a Pawn can be written to represent physical objects with Behavior logic for manipulation of the physical object. On the other hand, a Pawn may represent a completely non-physical object, such as an element of a computer-implemented game or mathematical concepts such as multi-dimensional mathematical objects that cannot be adequately represented in physical objects.

Shadow

A Shadow is a special stub form of a Pawn, and is associated with a Pawn (sometimes referred to as a real Pawn). A Pawn can have multiple Shadows associated with it. The Pawn and its Shadows communicate with each other to keep synchronized, exchanging States (described below) to reflect attributes changed by a Behavior which was caused to execute by a Command. The Pawn and its Shadows can reside in separate shared environments of the distributed system. In one embodiment, a Shadow is an object of the Pawn class, thus it contains a copy of all of the executable code contained in its associated Pawn, although the Command-Behavior mapping may differ between the Shadow and its associated Pawn. A Shadow is created by deserializing a Pawn object serialized using standard JAVA serialization techniques. Because deserialization does not call constructors, a rebuild method is provided by the Pawn class, which can be invoked by the Nengine upon deserialization to initialize the Shadow.

State

A State represents some attribute of a Pawn such as location or color. States are intended to be sent across the network from real Pawns to their Shadows and from Shadows to real Pawns in order to update attributes to keep the real Pawn and its Shadows synchronized. States are not CommandReceiver objects.

ControlDevice

A ControlDevice is a CommandReceiver used as an interface between hardware (such as an input device) and the shared environment. A ControlDevice's role is to transform the hardware's state into Commands that can be used within the distributed system. ControlDevices are not networkable.

Construct

A Construct is a CommandReceiver that has the ability to render Pawns that have graphical attributes on graphical displays connected to the computer on which the shared environment exists. “Render” as used herein refers to the process of adding realism to computer graphics by adding three-dimensional qualities such as Shadows and variations in color and shade. A Construct typically has a point of view in a scene constructed of the objects in a three-dimensional coordinate space, although other-dimensional coordinate spaces can be used. Those surfaces that fall within a field of view of the Construct are mathematically projected onto a plane, just as a real camera projects an image onto film. The rendering process necessarily involves some means of determining whether another surface closer to the point of view obscures a given surface of an object. Once it is determined what surfaces are visible at the point of view, and where they project onto the viewing plane, the color of each pixel must be determined. Depending on the sophistication of the process in a given case, the result is a combination of the surface properties assigned to the object (color, shininess, etc.) and lighting placed in the scene. Pawns can have an associated graphics level, which can be used by the Construct to decide whether to attempt to render the Pawn on a graphics hardware device which also has an associated graphics level. E.g., a slow PC might have a graphics level of 2, indicating it can only draw uncolored wireframes, while a fast supercomputer might have a graphics level of 10, indicating it can render moving textures on the surfaces of an object. Constructs can then use the graphics level to avoid attempting to render a Pawn with a graphics level of 10 on a slow PC with a graphics level of 2. The above graphics levels are exemplary and illustrative only, and other values and meanings for values can be used. E.g., a Pawn can also indicate that it can be rendered using OpenGL libraries or JAVA3D libraries, to indicate to the Constructs whether a given Construct can render the Pawn. The Pawn identifies itself as being renderable using a particular set of libraries by implementing a JAVA interface for those libraries. For example, if the JAVA3D interface is public interface Java3Drenderable {

public renderYourselfInJava3( );

}

then a Pawn which was to be renderable in Java3D would implement the interface, by indicating that the Pawn “implements Java3Drenderable” and including a public method “renderYourselfInJava3D” in the body of the class. The Construct would then render the Pawn by invoking the “renderYourselfInJava3D” method of that Pawn.

In general, there is one type of Construct for every type of graphical library implemented in the shared environment. Constructs are not networkable.

Network Engine (Nengine)

A Nengine is a CommandReceiver that mediates the connection between shared environments of the distributed system, each shared environment having its own Nengine. The Nengine transfers Pawns, Commands, and States (in addition to whatever other features may be supported, such as streaming media). A Nengine is not needed in a single shared environment system.

Node

Because a Pawn is a networkable object, it must have a representation on the network. A Node is the representation of a Pawn to the Nengine. All States, Commands, and other data are communicated to the Nengine through the Node. This is the Pawn's hook into the network. A Node is not a CommandReceiver object.

A Single Shared Environment System

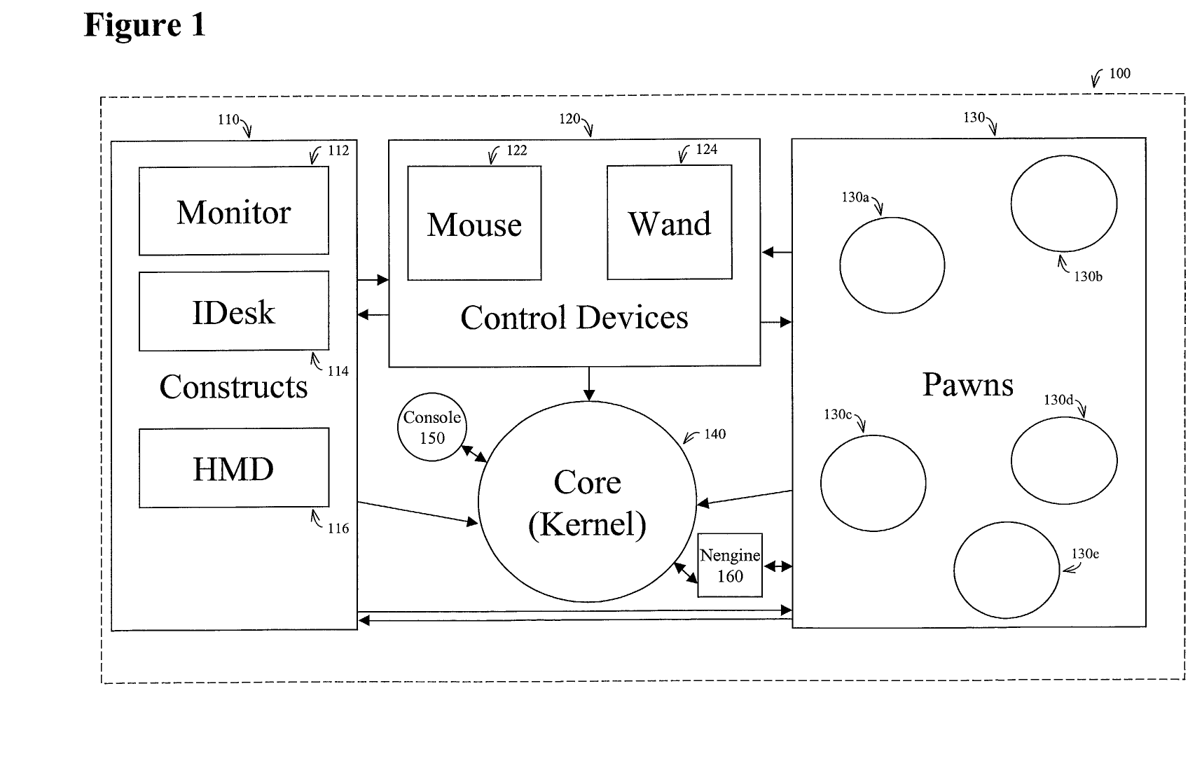

Turning now to FIG. 1, a single shared environment 100 according to a disclosed embodiment is illustrated in a block diagram. The shared environment 100 contains a collection of Constructs 110, ControlDevices 120, Pawns 130, and a Kernel 140, a Console 150 and a Nengine 160. The Constructs 110 shown in FIG. 1 include a display monitor 112, an ImmersaDesk (Idesk) 114 from Fakespace, Inc., and a Head Mounted Device (HMD) 116. These constructs are illustrative and exemplary only, and other Construct objects could be used, depending on the output hardware devices available and the graphical libraries available to render objects for display. However, each of the Constructs 110 are CommandReceiver objects, and the actual hardware device associated with each of the monitor 112, the Idesk 114, and the HMD 116 Constructs is not knowable by any other CommandReceiver.

The illustrated ControlDevices 120 include a mouse object 122 and a wand object 124. A wand is an input device for an Immersadesk. As with the Constructs, the ControlDevice objects are associated with hardware input devices, but the actual hardware input device associated with the ControlDevice object 122 or 124 is not knowable by other CommandReceiver objects in the system. These ControlDevices are illustrative and exemplary only, and other ControlDevice objects could be used, depending on the input hardware devices available.

For example, in a virtual reality game setting, a player of the virtual reality game may wear an HMD for display of the virtual reality graphics and use a head tracker, a device for monitoring the movement of the wearer's head or eyes, for controlling the graphics displayed on the HMD. In a visualization application, a computer monitor could be used to display the graphics via a Construct that used OpenGL libraries to render objects on the monitor, while a keyboard was used to provide input to the visualization application.

A Kernel 140 provides management services for the objects in the shared environment 100. As Pawns 130 are created, they are registered with the Kernel 140. The Kernel 140 can then inform other objects in the shared environment 100 of the newly registered objects. Although shown with a Nengine 160, a single system shared environment can be used without a Nengine 160. In a shared environment with a Nengine 160, the Kernel 140 informs the Nengine 160 that new Pawn 130 has been created. The Kernel 140 also informs other objects that a Pawn 130 has been destroyed.

Block 130 is a collection of Pawns 130a-130e. Any number of Pawns 130 can be created in the shared environment 100. Pawn 130a may communicate with Pawn 130b by sending Commands to Pawn 130b. The Pawns 130 are autonomous objects, acting independently of each other. In one embodiment, Behaviors of the Pawns 130 are private methods, and are thus not invokable by any other object.

The shared environment 100 manages the creation and destruction of all of the CommandReceiver objects 110-140. In one embodiment, hash tables are used for data storage, although any known technique can be used, including dedicated database programs.

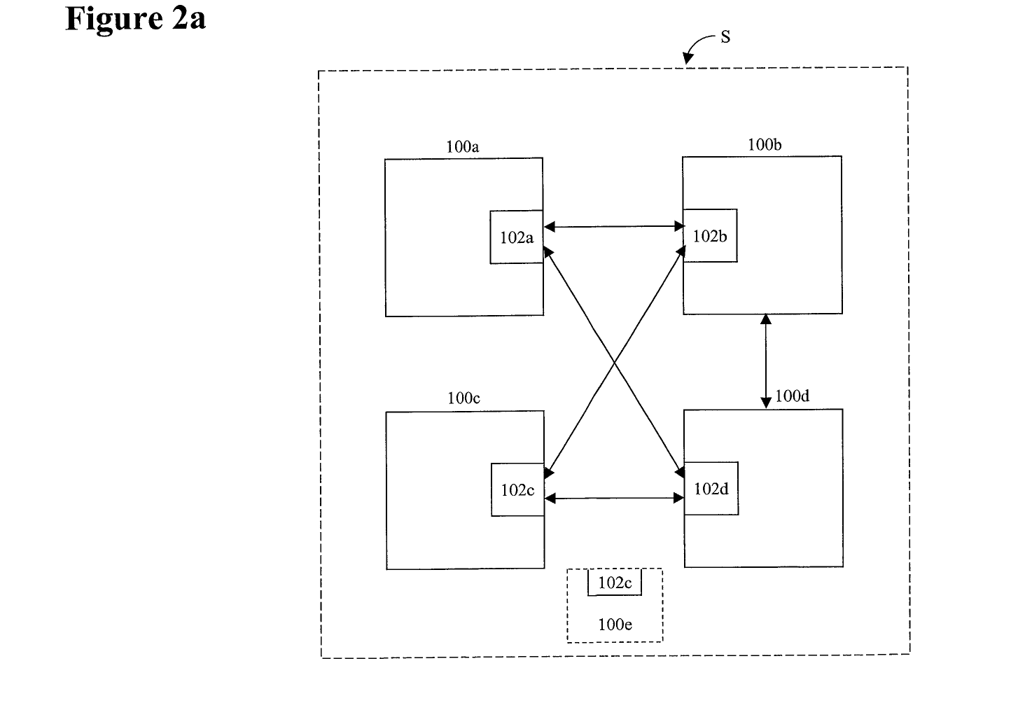

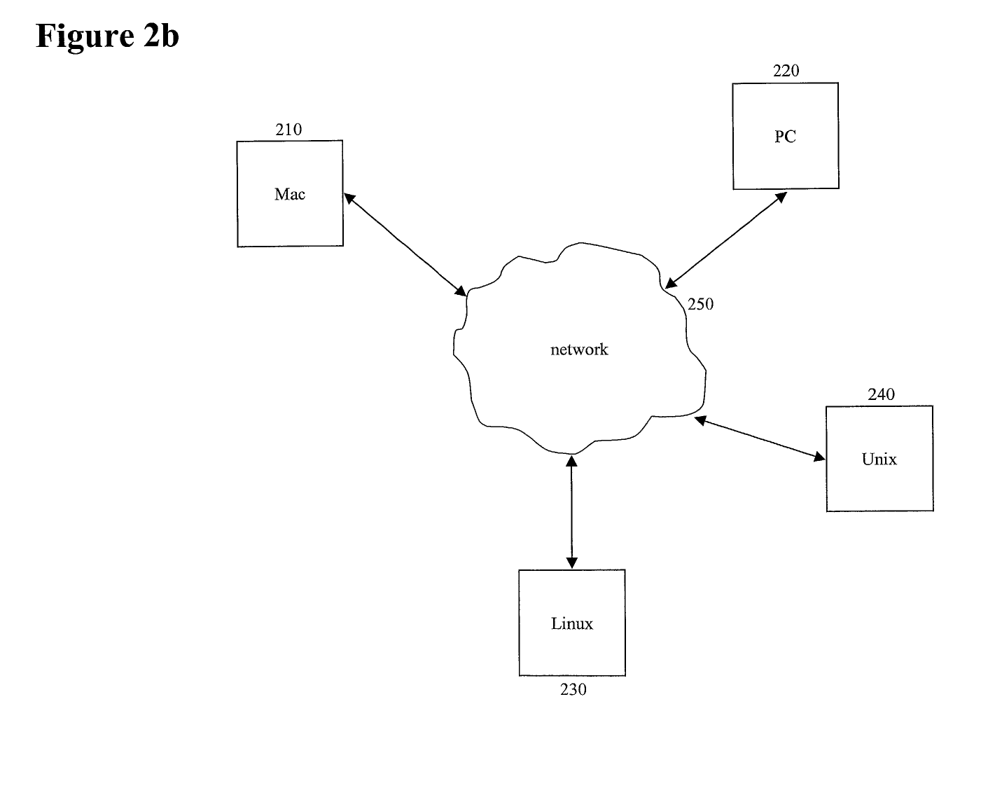

FIG. 2a shows a distributed system S composed of multiple shared environments 100. Each of the shared environments 100a-100d as shown in FIG. 2a is connected to each other of the shared environments 100. Although FIG. 2a shows a system S of four shared environments 100a-100d, any number of shared environments can be connected within the distributed system S.

In a distributed system S as shown in FIG. 2a, each shared environment uses a Nengine 160 to manage connections with each other shared environment 100. The Nengine 160 may, for example, maintain an array of all attached servers and a hashtable of all Pawns and Shadows. Connecting a new shared environment 100e (shown in dashed lines to indicate a newly created and unconnected shared environment 100) to the distributed system S causes the creation in shared environment 100e of Shadows of all Pawns belonging to shared environment 100a-100d. Likewise, shared environments 100a-100d will create Shadows of all Pawns belonging to shared environment 100e.

Turning to FIG. 2b, a distributed system S is shown implemented on multiple servers 210-240, each of which is a different type of computer system. Computer 210 is a MACINTOSH® from Apple Computer, Inc. running the MacOS operating system. Computer 220 is a personal computer (PC) from one of numerous PC manufacturers, running some version of the WINDOWS® operating system from Microsoft Corporation. Computer 230 is a computer running the Linux operating system, available from numerous sources. Linux operating systems run on multiple types of computer hardware. Computer 240 is a computer running the UNIX® operating system. Although UNIX is a registered trademark of The Open Group, UNIX operating systems are available from numerous sources and run on multiple types of computer hardware. Each of computers 210-240 is a conventional computer system, containing a processor, a keyboard, a display monitor, and storage devices such as memory and hard disks for storing the software of the disclosed embodiment. As shown in FIG. 2b, the distributed system S is platform and hardware independent, allowing Pawns on the Macintosh computer 210 to have Shadows on the PC computer 220, the Linux computer 230, and the UNIX computer 240. Likewise, Pawns on each of the PC computer 220, Linux computer 230, and UNIX computer 240 will have Shadows on each of the other computers in FIG. 2b. Further, the fact that the distributed system S is spread across four separate computers and types of computers connected via a network 250 will be invisible to the Pawns and Shadows executing on the computers 210-240. The illustrated computers and operating systems are illustrative and exemplary only, and the distributed system S can be implemented on other computer systems, using other kinds of hardware devices. In particular, the distributed system S could be implemented on a dedicated game device with plugin game modules containing game-specific Pawns.

Commands

Interaction between CommandReceiver objects in a shared environment 100 use messages that are Command objects. Any object in the shared environment 100 can send Commands to any CommandReceiver object in the shared environment 100. Commands have a type, such as “Move,” “Rotate,” “Grab,” etc. Commands can also have associated data parameters such as a translation vector. Different types of Commands can be implemented as subclasses of the Command class. For example, a GrabCmd class and a RotateCmd class may be classes that extend a Command class.

Pawns

Pawns are CommandReceiver objects that are networkable. Pawns can be created by other Pawns or by user interaction using the Console. As will be described below, Pawns are created by the Kernel 140 and registered with the shared environment 100.

As a CommandReceiver object, Pawns interact with the shared environment 100 through the use of Commands. A Pawn can receive and send Commands. Unlike conventional objects, where the Command directly invokes a public (i.e. exposed) method corresponding to the Command, the disclosed embodiment does not directly invoke the method corresponding to the type of the Command. Instead, the Pawn has a collection of Behaviors, implemented in one embodiment as private methods of the Pawn object.

Because they are private methods of the Pawn object, Behaviors are not invokable or visible external to the object. Even where Behaviors are public methods, they are not invoked directly by other objects. Therefore, an object sending a Command to a Pawn does not know what Behavior will be executed or the effect of executing the Behavior.

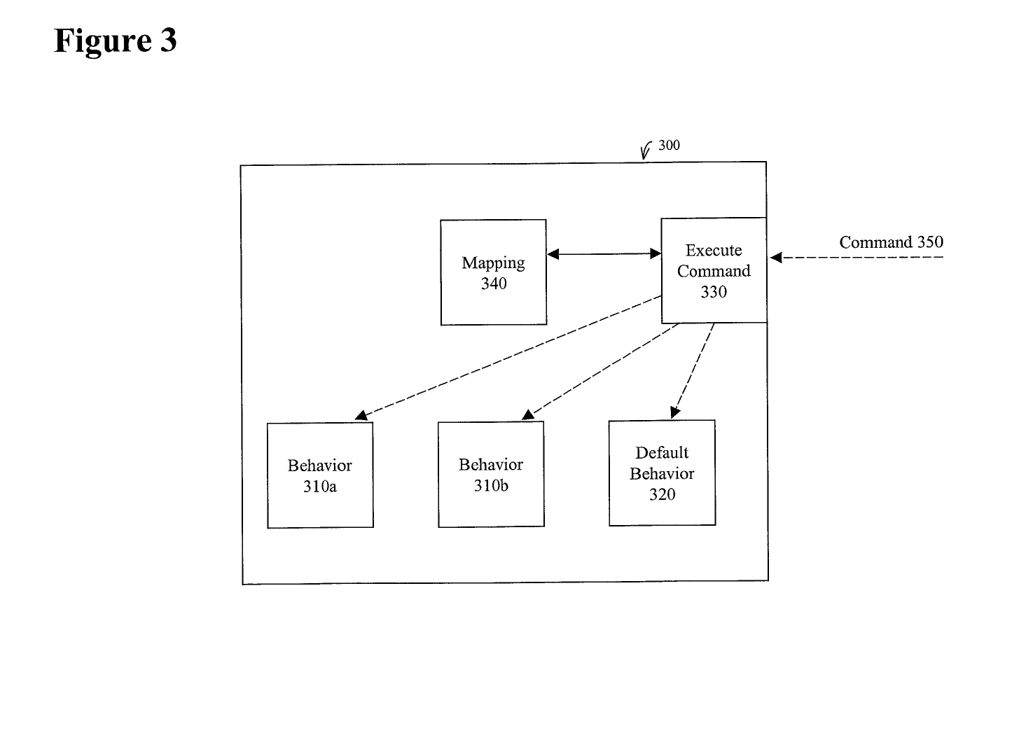

Turning to FIG. 3, an exemplary Pawn 300 is illustrated. The Pawn 300 has one public executeCommand method 330 which receives and executes a Command 350 sent by another object in the shared environment 100. Two Behaviors 310a-310b, a default Behavior 320, and a Command-Behavior mapping 340 are also shown in the Pawn 300. In one embodiment, the Pawn 300 can be implemented with no Behaviors 310, but every Pawn has a default Behavior 320.

When the executeCommand method 330 is invoked to process a Command 350, the method 330 uses the Command-Behavior mapping 340 to select which, if any, of the Behaviors 310 is to be invoked. The mapping 340 can be implemented using a hash table or any other convenient technique. In one disclosed embodiment, the mapping 340 may be an empty mapping, i.e., it may not map any Command 350 to a Behavior 310. In that embodiment, the Pawn 300 will process the Command 350 by invoking the default Behavior 320. In another embodiment, the mapping 340 can map some Commands 350 to one of the Behaviors 310, but not map other Commands 350. In that scenario, unmapped Commands will cause the invocation of the default Behavior 340, while mapped Commands will cause the invocation of the appropriate Behavior 310. Although two Behaviors 310a and 310b are shown, any number, including zero, Behaviors 310 can exist in the Pawn 300. Because the mapping 340 is used, however, the object sending the Command 350 does not know which of Behaviors 310a-310b or the default Behavior 320 will actually be invoked. Further, any parameters of the Command 350 can be adopted to match the parameters expected by the Behaviors 310 or the default Behavior 320.

In a further embodiment, the mapping 340 can be dynamically updated. Thus one execution of the Command 350 can cause the invocation of Behavior 310a and another execution of the Command 350 can cause the invocation of Behavior 310b or the default Behavior 320. In one embodiment, the mapping 340 can be created or updated from an external data source, such as a configuration file. The configuration file can be implemented in any convenient format. One format for a configuration file is a collection of “keyword=value” statements, which can be loaded and interpreted to set the indicated keyword variable to the indicated value. In another embodiment, modifying the mapping 340 is invoked by a Command 350, which executes a Behavior 310 to modify the mapping.

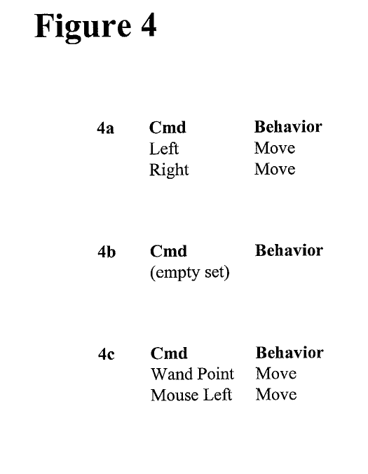

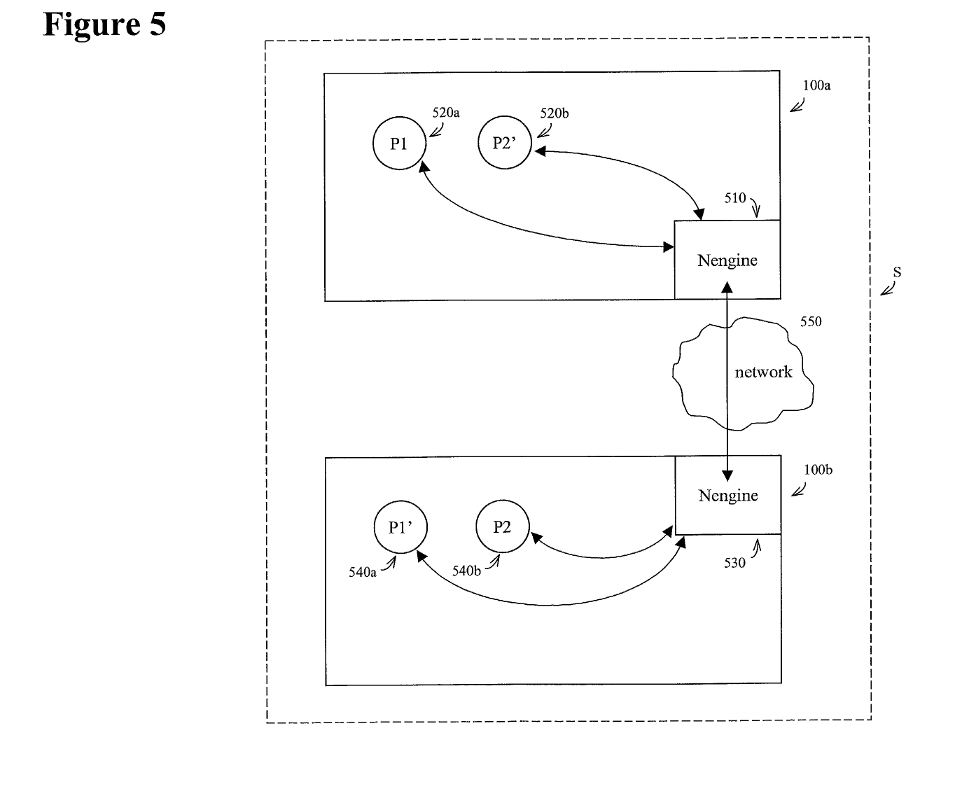

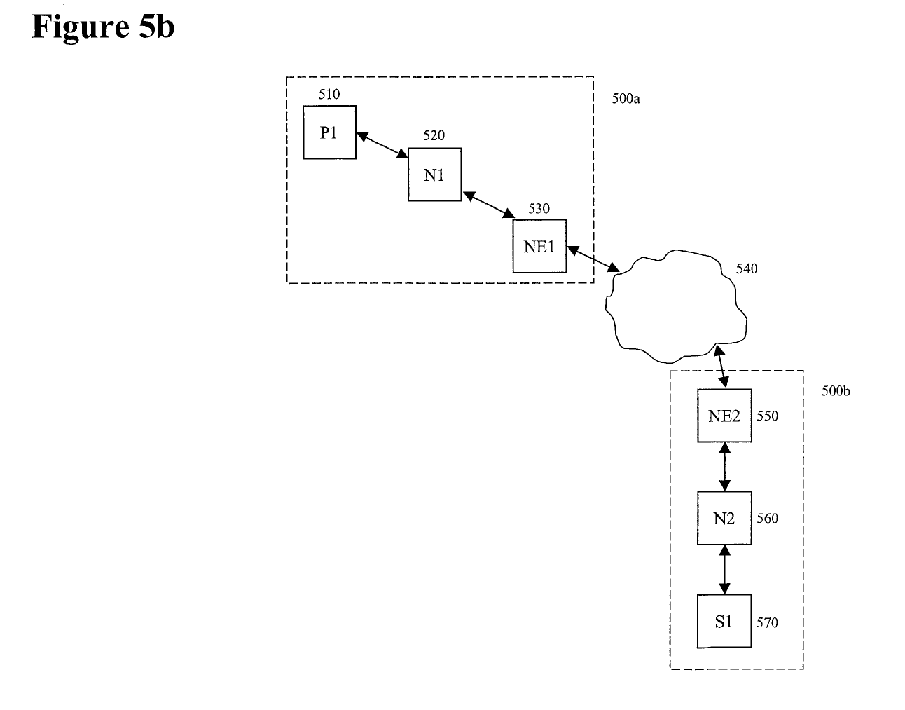

FIGS. 4a, 4b, and 4c illustrate exemplary Command-Behavior mappings that can be established by the mapping 340. Although FIGS. 4a-4c are shown in the format of a simple table for clarity of explanation, any technique for implementing a mapping 340 can be used. In one embodiment, a hash table is used. As shown in FIG. 4a, Commands of type “Left” and “Right” are both mapped to a “Move” Behavior. FIG. 4b shows that the mapping 340 can be empty, in which case all Commands 340 will cause the invocation of the default Behavior 320. FIG. 4c illustrates a mapping showing a WandPoint and a MouseLeft Command mapped to a Move Command. FIG. 4c illustrates that different ControlDevices, such as the Mouse 122 and the Wand 124 of FIG. 1, which can issue different types of Commands, can be mapped to a single Behavior of a Pawn 300, in FIG. 5c a Move Behavior. Again, neither the Mouse object 122 nor the Wand object 124 is aware that the Move Behavior will be invoked in response to a MouseLeft or WandPoint Command, nor does the Move Behavior invoked by the Pawn 300 know the nature of the ControlDevice issuing the Command which was mapped into the Behavior. This level of device independence has been unavailable in conventional distributed systems. One advantage of this level of device independence is that a Pawn 300 can handle new ControlDevices, each issuing different Commands, without recoding the Behaviors 310 of the Pawn 300, merely by updating the Command-Behavior mapping. An additional advantage is that existing ControlDevices can control new CommandReceiver objects without recoding the ControlDevice. Other advantages of this level of device independence for the reuse of existing objects will be recognized by one skilled in the art of object-oriented programming.

In addition, in one embodiment CommandReceiver objects can provide an authentication data to other objects, which then use that authentication data as a command. The authentication data acts as a key, allowing the CommandReceiver object to limit access to mapped Behaviors to only those objects having the key. In one embodiment, the authentication data is implemented by using a reference to a specific command. A Pawn (and any other CommandReceiver) can respond to commands with an action based on the Command-Behavior mapping. This would be a lookup by _type. However a Pawn (or other CommandReceiver) can also issue a specific reference to a command which invokes a specific behavior _instead of the generic mapping. This would be a lookup by reference. For example, a Pawn P1 may support a generic “move” command to which the Pawn P1 responds with the action “move” based on the a Command-Behavior mapping. However, another object P2 can also send a specific reference to a Command which invokes the behavior “jump” instead of the generic mapping. Thus when the object P2 sends a Move, the object jumps, but when any other object sends a Move, the object only moves.

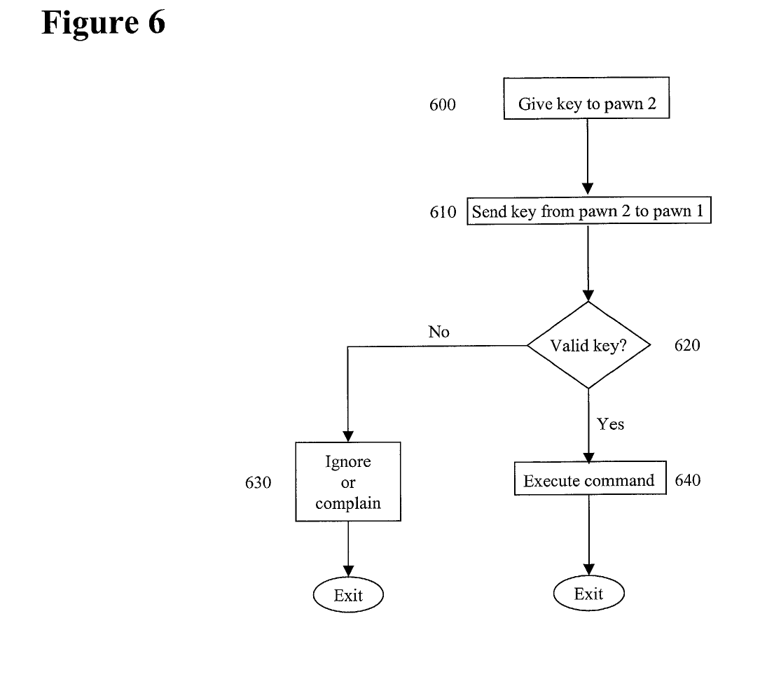

FIG. 6 is a flowchart illustrating the use of such a key or passing a Command by reference. In step 600, Pawn 1 gives a key, which is a reference to a Command, to Pawn 2. At some later time, Pawn 2 returns the key to Pawn 1 in a Command in step 610. In step 620, Pawn 2's executeCommand method validates the key. If the key is valid, i.e., the reference to the Command is found in the Command-Behavior mapping, in step 640 the Command is executed. If the key is not valid, the executeCommand method can ignore the command, attempt to lookup the Command by type, or take another error action coded by the software developer in step 630.

A Command-Behavior mapping is a separate piece of code that can be written for a CommandReceiver object much later and can essentially give it a new behavior that it did not have before. An application developer could use this technique to convert data from a new type of Command to an existing behavior. Because a Command-Behavior mapping is code, in addition to the mapping causing a Command to invoke a single Behavior, it can be configured to invoke multiple Behaviors of the CommandReceiver object. For example, if an application has a cube that only knows how to move in 3 dimensions, and the application developer wants to add a feature that would perform an animated jump based on a velocity, the application developer could use a Command-Behavior mapping. The mapping can receive a command Jump and call a Move Behavior several times in such a way that it would appear that the cube jumped. This can occur without changing one line of the cube object's code. Any object in a disclosed embodiment is provided this opportunity to add previously unthought of Behaviors. In essence, the mapping is an extended Behavior, but can only be based on existing Behaviors in the object.

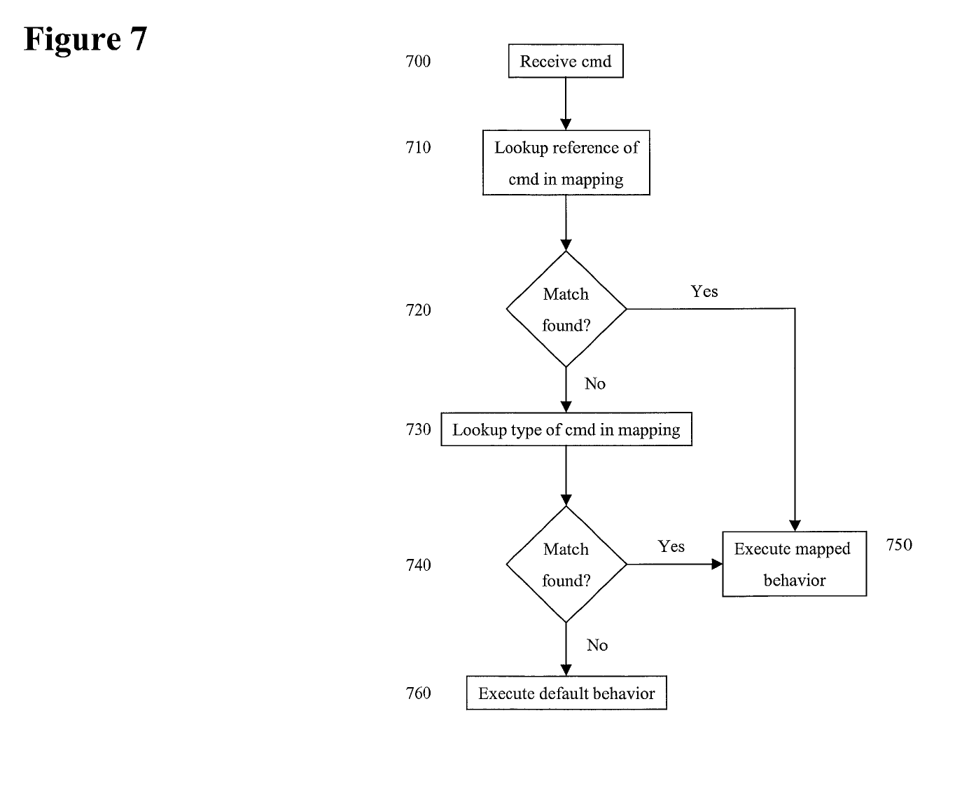

Turning to FIG. 7, a flowchart illustrating the steps of processing a Command is shown. In step 700, a CommandReceiver object receives the Command. In step 710, the CommandReceiver object attempts to lookup a reference to a Command in the Command-Behavior mapping. If a match is found in step 720, the mapped Behavior is invoked in step 750. If no match for the reference is found, the Command is looked up by type in the Command-Behavior mapping in step 730. Step 740 determines whether a match is found. If the command is mapped to a Behavior, in step 750 the mapped Behavior is invoked. Otherwise, the default Behavior is invoked in step 760.

One kind of Behavior can dynamically alter the Command-Behavior mapping by relinking the Commands to the Behaviors. Linking means adding a _value_ in a table to be looked up in step 730. That _value_ is the Behavior and mapping, and the _key_ to look up that value is the Command, which can be a reference. Although one embodiment uses a standard JAVA Hashtable class for providing the mapping, other techniques can be used. In particular, the JAVA HashMap class can be used.Shadows

The disclosed distributed system provides for creating Shadows of Pawns. A Shadow Pawn is a stub of a real Pawn, essentially copying the Pawn from one shared environment 100 into another shared environment 100. In one embodiment, the Shadow contains a complete copy of all the code of the Pawn, including the Behaviors 310 and default Behavior 320. However, the mapping 340 can vary among the Pawn and its Shadows.

Turning to FIG. 5, a distributed system S is shown with two shared environments 100a and 100b. Shared environment 100a uses Nengine 510 to communicate with shared environment 100b; shared environment 100b uses Nengine 530 to communicate with shared environment 100a. As shown in FIG. 5, each of shared environments 100a and 100b has a Pawn 520a and 540b, respectively. When the connection is made between shared environments 100a and 100b, Shadows 520b and 540a are automatically created. A software developer implementing the distributed system S can use data sets, textures, file names, or any other convenient data in the creation of the Shadow.

In the discussion below, “Pawn” will always refer to a real Pawn and not to its Shadow(s). Multiple Shadows can be created for a Pawn, with a Shadow created in every shared environment 100 of the distributed system S other than the shared environment 100 in which the Pawn exists. Further, a Shadow of a Pawn can be created in the same shared environment 100 as the Pawn.

Pawn-Shadow Interaction

Continuing with FIG. 5, all Pawns and Shadows are informed of the existence of all other Shadows. Pawns can also request to be informed of the creation or destruction of other Pawns.

Commands can be sent to both Shadows and Pawns. When a Command is sent to Shadow 540a in shared environment 100b, the Command is not executed by Shadow 540a, but sent to its associated Pawn 520a in shared environment 100a for execution. In one embodiment, a Command can be flagged as a local Command. A local Command is not sendable across the network 550, but is executed using the Command-Behavior mapping of the Shadow 520b to select a Behavior which then executes, resulting in sending a Command to the Pawn 540b.

When the Command is executed on the Pawn 520a, the Pawn 520a sends state information to its Shadow 540a to inform the Shadows and synchronize them with the Pawn 520a. Although the distributed system S of FIG. 3 contains only two shared environments, the Pawn 520a may send the state information to the Shadow 540a in every other shared environment of the distributed system S.

The Kernel

Referring back to FIG. 1, the Kernel 140 performs central management functions for the shared environment 100. One function of the Kernel 140 is to register new Pawns into the shared environment 100. Because the Kernel 140 is a CommandReceiver object, registering a new Pawn into the shared environment 100 involves sending a Command to the Kernel 140. An exemplary code sample for registering a new Pawn that represents a cube is as follows:

Pawn thePawn=new CubePawn(1);

executeSystemCommand

(new RegisterCommandReceiver(thePawn));

In the first line of the above code sample, a new Pawn named thePawn is created by an object as a Pawn representing a cube of size 1. In the next line of the code sample, the object sends the RegisterCommandReceiver command to register thePawn with the Kernel 140. The Kernel 140 will then inform other objects such as Constructs of the newly registered Pawn.

Other Pawns, the Nengine, and the Console can register new Pawns. When a Pawn registers a new Pawn, the newly created Pawn is registered as a subPawn of the original Pawn. A Nengine will register new Shadows with the Kernel 140 when Shadow information is received from the network.

States

States are sent from Pawns to Shadows to synchronize the Shadows with the Pawn. The programmer of the Pawn controls when to send the state to its Shadows. Sending a state is usually done in a Behavior of the Pawn using the sendState( ) method. Doing a sendState sends state information first to the Pawn's node, which sends the state information to the Nengine, which then sends the state information across the network to all other Nengines. The receiving Nengines then send the state information to the Shadows of the Pawn through their respective nodes.

In one embodiment, a Pawn can send state information to different Shadows at different rates. This can allow the Pawn to update only Shadows that are “close” to the Pawn in some measure or to update Shadows on faster computers at a different rate than Shadows on slower computers.

In a disclosed embodiment State handling is built in for all affine transformations (translate, rotate, and scale). However, a software developer can override the built-in state handling if desired.

Arbitration

A Pawn with multiple Shadows can receive Commands from those multiple Shadows simultaneously or within a predetermined time period that it will consider to be simultaneous. A software developer can choose to program the Pawn to deal with conflicts caused by receiving multiple Commands simultaneously in multiple ways. In one embodiment, the Pawn can pick a “first” Command, using any desired criteria, and ignore the others. In another embodiment, the Pawn can accept all of the Commands, resolving the conflicts by performing a single action equivalent to all of the actions or perform each of the actions sequentially. For example, if one Command says “move up two,” and the other says “move down one,” a Pawn according to this embodiment might perform both actions sequentially or a single action “move up one” action, with either case resulting in moving up one. In this embodiment, this procedure can present order-based instabilities where the result of performing two Commands can differ depending upon the order in which they are executed. In a third embodiment, the Pawn can choose a “winner” among its Shadows, using any desired criteria, and ignore Commands from other Shadows. One skilled in the programming arts will recognize that other techniques for resolving conflicts caused by receiving multiple Commands simultaneously can be used.

Networking

The distributed system S is not a traditional client-server system, but a peer-to-peer system. Therefore, the distributed system S may execute on a single server or on multiple servers. The network is transparent to all objects in the shared environment 100 except for the Nengine.

Each Pawn and each Shadow in a shared environment 100 has a node. Nodes are the means by which Pawns and Shadows talk to the distributed system S. Nodes contain a representation of Pawns and Shadows in the shared environment 100. Each node automatically grabs Commands and states being sent to the Pawn or Shadow. Nodes that correspond to Shadows send Commands to the Pawn, and nodes that correspond to Pawns will send states to the Shadows. Pawns do not send Commands to Shadows of other Pawns. FIG. 5B illustrates this Pawn-Shadow cross-network interaction. When Pawn 510 in shared environment 500a receives a Command, as part of the execution of the Command, it sends a State reflecting updates to Pawn 510's attributes to Pawn 510's Shadow 570 in shared environment 500b. The State is first sent to the Node 520 associated with Pawn 510. Node 520 then sends the State to the Nengine 530, which serializes the State for transmittal over the network 540 to Nengine 550. Nengine 550 deserializes the State and sends the state to Node 560, which is associated with Shadow 570. Node 560 then updates the attributes of the Shadow 570, synchronizing the Shadow 570 with the Pawn 510. In the other direction, if Shadow 570 receives a Command, Shadow 570's Node 560 grabs the Command and sends it via the Nengines 550 and 530 and the network 540 to the Node 520 associated with Pawn 510, which then sends the Command to the Pawn 510. After processing the Command, Pawn 510 then sends a State back to Shadow 570 as described above.

The network is transparent to most objects in the shared environment 100. The only object that interacts with the network is the Nengine object. The Nengine serializes information being sent to the network and deserializes data being received from the network. The Nengine can use any serialization technique. In one embodiment, the serialization technique uses the extensible markup language (XML). The Nengine can use any networking protocol available.

In the shared environment 100, the Kernel 140 informs the Nengine whenever a new Pawn is created. The Nengine then sends information to create Shadows of the Pawn to all other Nengines in the distributed system S. Likewise, when a new shared environment 100 joins the distributed system S, its Nengine sends information to create Shadows of all the Pawns of the Nengine to all other Nengines in the distributed system S and all of the Nengines previously existing in the distributed system S send information to create Shadows of their Pawns to the new Nengine. The resulting distributed system S will have Shadows of each Pawn in every shared environment 100 other than the shared environment 100 in which the Pawn itself is located.

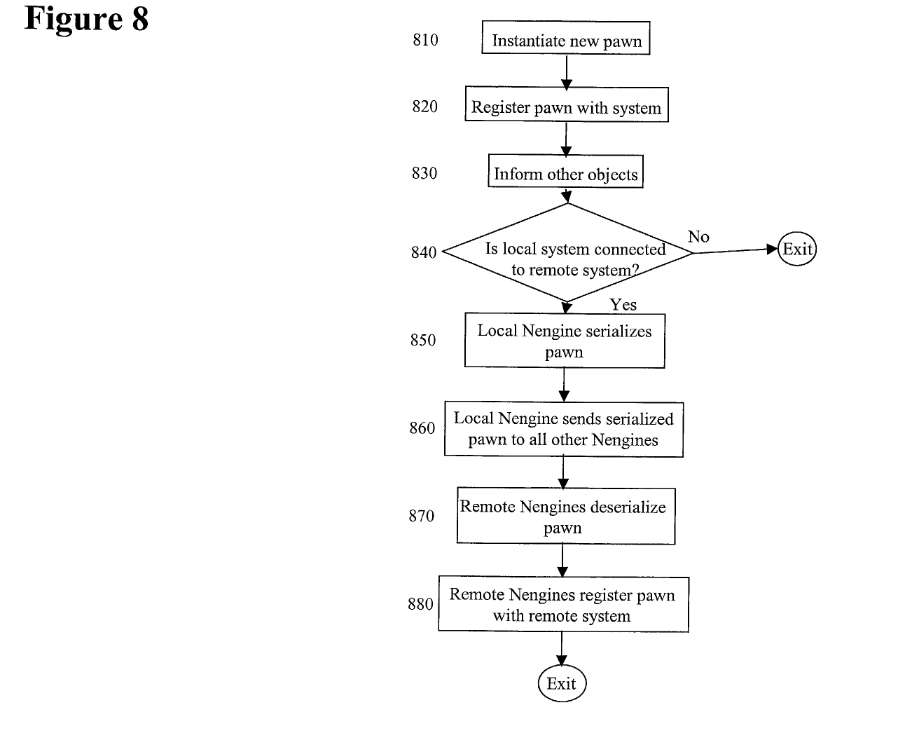

FIG. 8 is a flowchart showing the steps involved in this process. In step 810, the local shared environment 100 instantiates a new Pawn. Other objects in the shared environment 100 are informed of the new Pawn in step 820. If the local system is not connected to a distributed system S in step 840, nothing else is done. Otherwise, in step 850, the Nengine serializes the new Pawn, sending the serialized Pawn to all other Nengines in step 860. Each remote Nengine then deserializes the Pawn in Step 870, creating a Shadow of the original Pawn. Finally, in step 880, the remote Nengine registers the Shadow with the Kernel of the remote system.

When a Nengine determines that connection to another Nengine has been lost, the Nengine must decide what to do about the connections between Pawns and Shadows. If the remote shared environment contained no Pawns but only Shadows of Pawns on the local shared environment, the local Nengine will simply stop sending states to the other shared environment. If however, the local shared environment contains Shadows of real Pawns on the now disconnected shared environment, the local Nengine must decide what to do with those Shadows. A Pawn can be marked as mutable or not mutable. If the Pawn on the remote Nengine is marked as not mutable, then all the Shadows on the local Nengine will be destroyed. If the remote Pawn was marked as mutable, then multiple techniques for handling the Shadows on the local Nengine are available. In one embodiment, all Shadows in each of the remaining shared embodiments 100 are promoted to real Pawns, with no connection to each other. In another embodiment, the Pawn at some point prior to the disconnection indicated which Shadow should be promoted to real. In this scenario, the appropriate Shadow is promoted to a real Pawn, and other Shadows of that Pawn are converted to Shadows of the new Pawn. In a third embodiment, a form of election can be held to decide which Shadow becomes a real Pawn, the other Shadows being converted to Shadows of the new Pawn.

ControlDevices

All ControlDevices use the same protocol, so they look identical to the rest of the shared environment 100. ControlDevices can be connected or disconnected from Pawns at any time. Pawns do not need to be connected to any ControlDevice. The Kernel 140 is not involved in the connection or disconnection of ControlDevices from Pawns.

In one embodiment, a multiplexer ControlDevice allows integrating a number of physical devices into a single ControlDevice object. In another embodiment, connection of ControlDevices to Pawns at initialization of the shared embodiment 100 or creation of a new Pawn can be accomplished by defining channels for communication between the ControlDevice and the Pawns. In this embodiment, sending channels and receiving channels are defined. A ControlDevice can have multiple sending channels while a Pawn can have a single receiving channel. Multiple sending channels can be connected to a receive channel. This allows connecting multiple ControlDevices to a single Pawn. Likewise, multiple receive channels can be connected to a sending channel. This allows connecting multiple Pawns to a single ControlDevice. Different sending channels from a ControlDevice can go to different Pawns. For example, a shared embodiment 100 may contain a mouse ControlDevice 122 and a robot Pawn 130a and a tank Pawn 130b. By connecting different channels from the mouse ControlDevice to the two Pawns 130a and 130b, a left click of the mouse can control the robot device 130a while a right click on the mouse can be used to control the tank Pawn 130b.

In one embodiment, a shared environment 100 can contain a ControlDevice that knows how to poll a joystick, such as with a polling loop. The ControlDevice can query the joystick for its state at desired times, determining the position of the joystick. The ControlDevice can hold a reference to an object that is to be the destination for its commands. When the ControlDevice goes through its polling loop, it checks to see if the joystick is not centered. If the joystick is not centered, then the ControlDevice sends a command to the destination CommandReceiver object, based on the reference held by the ControlDevice, informing the CommandReceiver object of the orientation of the joystick. Although the command sent by the joystick ControlDevice could be a joystick-specific command, such as “JoystickLeft,” because of the device independence of the disclosed embodiment, the command sent by the ControlDevice could be a more generic command, such as “MoveLeft.”

Constructs

Constructs enable output devices such as monitors or HMDs to implement an interface that allows the construct to render Pawns. Constructs indicate to the Kernel 140 that the constructs are to be informed of the creation of Pawns 130. A construct 110 will then grab any Pawn 130 that implements an interface that the construct knows how to render. The Pawns 130 do not need to know anything about how to render themselves. Multiple constructs can render a single Pawn 130 on different physical devices.

Hardware Independence

The distributed system S and the shared environment 100 are implemented in a platform-independent fashion. In one embodiment, the shared environment 100 and the distributed system S are implemented in the JAVA language from Sun Microsystems. Pawns and Constructs can implement any graphical library convenient to the software developer. In particular, Constructs can implement and render Pawns on any form of graphical display in either a stereo or mono technique. Likewise, because ControlDevices hide physical devices from the Pawns, the Pawns can be input device independent.

Implementation

In one embodiment, the shared environment 100 is implemented using the JAVA® language from Sun Microsystems, Inc. Because the JAVA language is extensible, developers of shared environments 100 have access to the full power of the JAVA language, instead of being limited to a scripting language subset. That includes APIs such as the JAVA3D™ API defined by Sun Microsystems, Inc. Other extensible object-oriented programming languages could also be used, although preferably an object-oriented programming language that is implemented for multiple computer platforms is used. Each shared environment resides on a computer system that provides operating system and run-time support for the underlying object-oriented programming language.

In one implementation, the distributed system is implemented using the following JAVA classes and interfaces. Table I shows a class hierarchy chart, indicating the inheritance relationships between the described classes by indentation. For example, the Pawn class is a subclass of the CommandReceiver class, as shown by the indentation.

TABLE I
Class Hierarchy

Attach
AttachGranted
CmdWrapper
CommandReceiver

Command

AddComponentCmd
AddPawnCmd
ConnectCR
GetCommandReceiverCmd
GetCommandReceiverWithIDCmd
GetComponentCmd
GetEnvironmentVariableCmd
GetSubPawns
GrabCmd
PlayCmd
RegisterCommandReceiver
RegisterRegistrationListener
ReleaseCmd
SetEnvironmentVariableCmd
TimerCmd
TransformCmd

GrabRotateCmd
GrabTranslateCmd
LocateCmd
OrientCmd
RotateCmd
ScaleCmd
TranslateCmd

UnregisterCommandReceiver

Console

TextConsole

Construct

Java3Dconstruct

DeskConstruct
StereoConstruct

ControlDevice

Keyboard
Mouse
Mux
PlayBox
SpaceOrb

GetComponentCmd
Kernel
Nengine
NetworkEngine
Pawn

GPawn

Java3DPawn

Empty
Java3Dhead
Loader
Loader3ds
PointLight
Primitive

Cube
Cylinder
Sphere

CommandReceiverFactory
ConfigLoader
ConsoleCommand

connect
inject
kill
ls
netthrottle
quit
saveoutput
setenv

Jwindow

Splash

KillPawn
NetNode

StdNode

ObjectFactory
OtherHosts
PawnID
PawnWrapper
ReqState
SocketWrapper
State

TransformState

StateWrapper
Thread

AttachListener
StateUpdater
TCPListener
TimerCmdGenerator
UDPListener

Throwable

BehaviorFlag

Table II shows an interface hierarchy chart, indicating which classes implement which interfaces by indentation. The “networkable” interface extends the serializable interface, and is not a class.

TABLE II
Interface Hierarchy

ActionListener

PlayBox

ConfigUser

Kernel
Mux
SpaceOrb

Head

Java3Dhead

Map
PawnListener
RegistrationListener
Renderable

GPawn
Java3DRenderable

runnable

Construct
Mouse
NetworkEngine
SpaceOrb

serializable

Attach
AttachGranted
AttachListener
CmdWrapper
KillPawn
networkable

Command
NetNode
Pawn
State

OtherHosts
PawnID
PawnWrapper
ReqState

StateWrapper

AddComponentCmd

This class adds another component to the potential focus area for ControlDevice. AddComponentCmd is a subclass of the Command class.

AddPawnCmd

This class is a subclass of the Command Class. This class sets a Pawn to an event set.

Attach

This class implements the standard JAVA Serializable Interface.

AttachGranted

This class implements the standard JAVA Serializable Interface.

AttachListener

This class is a subclass of the thread class and listens to a Nengine port. Once attached, AttachListener spawns a ControlListener for every computer that attaches. This class has public methods to start, run and stop the AttachListener.

BehaviorFlag

This class is a subclass of the standard JAVA Throwable class. This class is an exception to flag behavior methods.

CmdWrapper

This class implements the standard JAVA Serializable Interface.

Command

This class is an abstract class that implements the networkable interface. The Command class provides methods for setting and getting a priority variable and setting and checking a class variable indicating whether the object is sendable.

CommandReceiver

This class is the super class for all of the major objects of the distributed system. This class allows the reception of commands and the linking of commands to object behaviors. This class has an executeCommand public method that tells an instance of the CommandReceiver object to respond to a Command. If there is no Command-Behavior linking, then the default Behavior is called. Two other public methods, link and unlink allow dynamic manipulation of the Command-Behavior mapping.

In order to remove the need for application programmers to rewrite the executeCommand method for every CommandReceiver object, the executeCommand method is a public method of the CommandReceiver class. Whenever executeCommand is invoked on a subclass of CommandReceiver, the executeCommand method defined in the superclass is invoked by the JAVA runtime system. However, because of standard scoping rules, a Behavior of the subclass object that is a private method of that subclass cannot be invoked by the superclass's executeCommand; any attempt to do so will cause an exception.

In the JAVA language and other object oriented languages, a method is designated as being visible either:

(1) to everyone (public)

(2) to subclasses only (protected)

(3) to itself only, such that subclasses are unaware of the method (private)

A parent or superclass cannot call protected or private methods defined by a child or subclass. Therefore, an attempt to invoke a private method of a subclass from an executeCommand method of the superclass will cause an exception or error.

In one disclosed embodiment, a JAVA byte-code translator can be provided to relax the scoping rules to allow the executeCommand method to be defined only in the superclass CommandReceiver. The byte-code translator modifies certain predetermined methods in every class defined in the shared environment. The byte-code translator adds a special method to every class that allows the CommandReceiver version of executeCommand to tell one of its subclasses to invoke a Behavior method, regardless of its scope. The byte-code translator modifies JAVA class files on the byte-code level in order to add this method. Although the byte-code translator manipulates JAVA byte-code data, one skilled in the art will recognize that a similar tool could be used for other object-oriented languages. One skilled in the art will further recognize that other techniques for relaxing the scoping rules of the object-oriented language used to implement an embodiment could be used and that embodiments can be created which do not manipulate the scoping rules, but require the executeCommand method to be rewritten for the subclasses of the CommandReceiver class. Other object-oriented languages with different scoping rules can also be used.

CommandReceiverFactory

This is an auxiliary class with static methods to dynamically instantiate CommandReceiver objects. The constructor for this class takes a parameter that is a configuration file that can be used to create the CommandReceiver.

ConfigLoader

This class is a configuration file loader for all classes to use. Every line of the configuration file, except for comments, is of the form keyword=value. When a valid configuration file line is found, it is read and then the processconfig method of the calling class is invoked with the information from the line. A protected method loadconfig loads a configuration file into hash tables, indexed by keywords. Other protected methods store string and number values associated with a keyword. This class has public methods for getting keywords, the strings associated with the keyword, and doubles associated with the keyword.

ConftgUser

This is an abstract interface describing a class that loads configuration files using ConfigLoader. The interface defines a processconfig method. The interface is called on every valid line of the configuration file read by the ConfigLoader. This method should handle the different keywords that the class needs to use.

Connect

This class is a subclass of the ConsoleCommand class and connects a local server to a remote server. A single public method “execute” is invoked to make the connection.

ConnectCR

This class is a subclass of the Command class. This class sets the CommandReceiver specified as a parameter to receive Commands piped through a specified channel on a destination ControlDevice.

Console

This class is a subclass of the CommandReceiver class and defines an abstract system console. Public methods hand a reference of the Kernel to the console; print error messages; print a line on the console; save all of the output produced by the shared environment to a file; and process commands for the console.

ConsoleCommand

This class defines commands to be issued by a console. Public methods provide for executing the console command, determining the Kernel for the shared environment, and establishing a console if no console has been created.

Construct

This class is a subclass of the CommandReceiver class and implements the runnable interface. This class is an abstract class for rendering Pawns using the Java3D graphical libraries. This class allows registering a Pawn to add a Pawn to the shared environment, which is called whenever a Pawn is added to the shared environment. Likewise, a method to remove a Pawn from the virtual environment is called whenever a Pawn is removed from the shared environment.

ControlDevice

This is a class describing attributes of any ControlDevice. A ControlDevice models an input device, generating its output on “channels.” If a ControlDevice receives a connect command, the ControlDevice will connect a CommandReceiver to a channel of the ControlDevice. An abstract protected method sets a specified CommandReceiver as a receiver of data on a specified channel. Subclass implementations of the ControlDevice class implement specific behaviors of this method.

Cube

This class is a subclass of the Primitive class. It creates a Cube of a specified size.

Cylinder

This class is a subclass of the Primitive class. It creates a Cylinder of a specified radius and height.

DeskConstruct

This class is a subclass of the Java3DConstruct class and is a Construct for display on a desktop monitor.

Empty

This class is a subclass of the Java3DPawnclass and creates a Pawn with no graphical appearance.

GetCommandReceiverWithIDCmd

This class is a subclass of the Command Class.

GetCommandReceiversCmd

This class is a subclass of the Command Class and generates a vector of all the Kernel CommandReceiver containers that contain CommandReceivers of a certain type.

GetComponentCmd

This class is a subclass of the Command Class and is used to get a component from a CommandReceiver.

GetEnvironmentalVariableCmd

This class is a subclass of the Command Class and is used to obtain the value of an EnvironmentVariable from the Kernel.

GetSubPawns

This class is a subclass of the Command Class and is used by the Kernel to obtain a vector of subPawns from a Pawn.

GPawn

This class is a subclass of the Pawn class and implements the renderable interface. This class is an abstract Pawn having a graphical attribute. Class variables define a graphical level for rendering the Pawn. Methods of this class allow obtaining the position of the Pawn local to its parent, the global position of the Pawn, the relative orientation of the Pawn local to its parent, the global orientation of the Pawn, the relative scale of the Pawn local to its parent and the absolute scale of the Pawn. The default behavior of this CommandReceiver object is to handle affine commands to translate, locate, rotate, orient, and scale the Pawn.

GrabCmd

This class is a subclass of the Command class and provides a Grab Command to the shared environment. No methods are defined in the class.

GrabRotateCmd

This class is a subclass of the TransformCmd class and is used for rotating a Pawn.

GrabTranslateCmd

This class is a subclass of the TransformCmd class and provides a move command.

Head

This is an interface representing a viewpoint, i.e. and avatar's head. This interface is used by a Construct to generate a view and by an avatar to specify a head. Public methods allow setting and getting an interocular distance. Other methods allow getting and setting a front and back clip distance.

Inject

This class is a subclass of the ConsoleCommand class and provides an inject command to load a CommandReceiver into the shared environment. A single public method “execute” loads the CommandReceiver.

Java3DConstruct

This class is a subclass of the Construct class. This class constructs a scene graph with methods to create and view branches of the graph, specify a head to use for a viewpoint calculations, and add or remove renderable objects to the scene.

Java3DHead

This class is a subclass of the Java3DPawn class and implements the Head interface. Therefore, it provides concrete methods for all of the methods of the Head interface.

Java3DPawn

This class is a subclass of the GPawn class and implements the Java3DRenderable interface. This class contains methods for associating States and Nodes with a Pawn, making the Pawn renderable, and connecting the Pawn a scene graph. In addition, this class provides behaviors for affine transformations of the Pawn.

Java3DRenderable

This interface is a subinterface of the renderable interface and describes the methods a Java3DRenderable Pawn must have in order to be usable by a Java3Drenderable-capable construct. Its methods return the graphical representation of the Pawn, return the 3D transformation of the scene graph group containing the Pawn, return the Pawn associated with a given Java3D node, and indicate whether the Pawn is a subPawn of another Pawn.

Kernel

This class is a subclass of the CommandReceiver class and implements the ConfigUser interface. Class variables implement a hatch table and manage vectors for registration listeners. The Kernel is configured using concrete methods of the ConfigUser interface to load a configuration file and configure the Kernel based on the parameters in the configuration file. Other methods notify registration listeners of a new CommandReceiver being registered or unregistered from the distributed system. The Kernel will typically be the first CommandReceiver to begin running. As a CommandReceiver object, the Kernel has a default behavior, which is to execute commands passed to the Kernel.

Keyboard

This class is a subclass of the ControlDevice class. Keyboard is ControlDevice that uses the mouse and keyboard to control Pawns. A specified character will serve as a toggle character.

Kill

This class is a subclass of the ConsoleCommand class and provides a command to unregister a specified CommandReceiver from the distributed system.

KillPawn

This class implements the serializable interface and is used for removing a Pawn.

Loader

This class is a subclass of Java3DPawn. This is a Pawn that loads a file using a standard Java3DLoader technique. If a valid scene exists, a new branch is created to the Pawn.

Loader3ds

This class is a subclass of the Java3DPawnClass and provides a Pawn that loads the file using a standard Java3DLoader technique.

LocateCmd

This class is a subclass of the TransformCmd class and sets the location of the specified Pawn.

ls

This class is a subclass of the ConsoleCommand class and lists all registered CommandReceiver objects by sending a GetCommandReceiversCmd to the Kernel.

Map

This interface maps the fields of a Command to the parameters of a behavior. This allows the application developer to make any Command work with any Behavior. The interface returns an array of objects that correspond exactly to the target behavior parameters. An object implementing the Map interface can have code which maps a single Command to a single or multiple Behaviors.

Mouse

This class is a subclass of the ControlDevice class and implements the runnable interface. The class defines variables for mouse tracking and processing. In addition, methods handle mouse events such as pressing a button, releasing a button, and listening for mouse movement. As a ControlDevice, the Mouse class provides for affine transformation of Pawns.

Mux

This class is a subclass of the ControlDevice class and implements the ConfigUser interface. This class is a ControlDevice that mediates between real ControlDevices and Pawns in such a way as to facilitate ease in using multiple ControlDevices. It maps between Pawn channels, requested by the Pawn, and ControlDevice channels, which are written to by the ControlDevice. The Mux class allows easy configuration of Pawns and ControlDevices by mapping the Pawn channels into ControlDevice channels. A configuration file is used to specify the mapping. One method processes the configuration file. As a ControlDevice, this class defines Behaviors, which connect a CommandReceiver to a channel, add a ControlDevice to the Mux, and create the channel mapping.

Nengine

This class is a subclass of the CommandReceiver class and is the network engine for the distributed system. The Nengine opens three threads for port listening: a UDPListener, for holding a fast connection to the group of Nengines in the distributed system, a TCPListener, to hold an ensured connection to a computer, and an AttachListener, which listens for new connections from other Nengines. The Nengine maintains hash tables for Nodes of all Pawns and Shadows, and an array of all attached computers. A Nengine is paired with a StdNode. Although one disclosed embodiment uses UDP and TCP connections, any networking technique could be used. Once a Nengine is registered with the Kernel, it registers itself with the Kernel as a Command listener using a RegisterRegistrationListener Command. The Nengine creates a node for each Pawn registered with the Kernel. If the Pawn already has a node, the Pawn is registered as a Shadow. Shadows without real Pawns can be held for connection to a real Pawn to be registered. The Nengine sends every newly registered Pawn to all other connected shared environments of the distributed system using a sendPawn method. A registerPawnFromNet method receives Pawns sent from other shared environments and creates Shadows. Other methods locate an identified Pawn, remove a Pawn from the Nengine, gets all Pawns and Shadows, send States to all networked Shadows, add and remove computers from the distributed system, send Commands to Pawns, and attach to and detach from remote computers.

NetNode

This class implements the Networkable interface and provides the Node described above. A Node is an abstract network representation of a Pawn for the NetworkEngine. Methods process Commands received by a Shadow, sending the command to the Pawn, and Commands received by a Pawn, which are processed by the Pawn.

Netthrottle

This class is a subclass of the ConsoleCommand class. The class connects to a remote server and sets a refresh delay for the server, allowing a user at the console to set a delay value to control how often a Nengine updates a scene. If a graphical structure is updated too often, then graphical rendering software such as java3d may not actually render the graphical object. This problem usually arises when the network connecting the distributed system is fast and objects are being moved or the point of view is being moved around the object very quickly. The object is updated so often that the computer system never has time to render the object. In a disclosed embodiment, the Nengine is configured to only update an object on a periodic basis, using a delay value to define the period. The Netthrottle Command allows controlling the delay value.

Networkable

This interface contains generic attributes of any networkable object and is a subinterface of the standard JAVA Serializable interface. Methods provided get and set priority and sendability variables. The priority variable indicates the a network transmission protocol. In one embodiment, two priority values are provided: UDP and TCP. In a further embodiment, other values such as SSH can be provided. The UDP priority can be used for relatively faster, but unreliable transmission, where there is no requirement that the recipient ever receive the transmission. For example, a Nengine N1 notifying other Nengines in the distributed system that Nengine N1 has joined the distributed system would generally use the UDP priority for such notification. The TCP priority can be used for relatively slower, but reliable transmission, where the recipient must receive the transmission. For example, delivery of State information from a Pawn to its Shadows will generally use the TCP priority. The SSH priority can be used for relatively slower than TCP transmissions that are encrypted, where such security protection is required. One skilled in the art will recognize that the above priority values are illustrative and exemplary, and other priority values can be used. In particular, if transmission protocols other than TCP/IP are used, other priority value can be used.

ObjectFactory

This class is an auxiliary class to dynamically instantiate objects from class names. Parameters contain the class name and arguments for the class constructors. If successful, the new instance is returned.

OtherHosts

This class implements the standard JAVA Serializable interface. It keeps a list of all the other computers on the network in the distributed system and has methods to provide that list as well as the Internet addresses of those computers.

PawnID

This class implements the standard JAVA Serializable interface. Objects of this class hold a Pawn's identification (ID) value, which consists of the IP address of the Pawn and a number unique to the local machine. Methods create an ID from the IP address and unique number, as well as returning the entire ID or the IP address portion of the ID.

OrientCmd

This class is a subclass of the TransformCmd class, and is a Command for setting the orientation of a Pawn.

Pawn

This class is a subclass of the CommandReceiver class and implements the Networkable interface. Pawns and Shadows are instances of this class. Class variables store information about the mutability of the Shadow. Methods can be invoked to make the Pawn a child of a parent Pawn, return the ID of the parent Pawn, and set or get the ID of the Pawn associated with a Shadow, create subPawns of the Pawn, and get a list of the subPawns of the Pawn. Other methods return a State with a complete set of attributes of the Pawn. The default Behavior of the Pawn can process a GetSubPawns Command, in addition to the standard default Behavior of CommandReceiver class objects. Other Behaviors include adding a PawnListener for the Pawn.

PawnListener

This interface defines the attributes of an object that listens to the Commands of another Pawn. An onCommand method is invoked by the Pawn being listened to when it receives a Command.

Pawn Wrapper

This class implements the standard JAVA serializable interface. Class variables store a Pawn, the ID of the parent Pawn, and the State of the Pawn, while methods allow getting each of those variables. A Nengine uses a PawnWrapper to transmit a Pawn over the network to the other Nengines in the distributed system.

PlayBox

This class is a subclass of ControlDevice and implements the ActionListener interface. This is a control device that sends PlayCmd Commands to a CommandReceiver.

PlayCmd

This class is a subclass of Command. The PlayCmd Command instructs a CommandReceiver that has item-dependent functions, such as audio or an animation. A PlayCmd Command instructs the CommandReceiver to perform actions such as reverse, back, stop, and step.

PointLight

This class is a subclass of the Java3DPawn class. A Pawn of this class represents a point light source.

Primitive

This class is a subclass of the Java3DPawn class and defines an abstract primitive shape pawn, using standard Java3D techniques. Methods allow loading the State associated with the Pawn and setting the color settings of the Pawn. Behaviors allow setting the unlit, ambient, diffuse, emissive, and specular color of the shape and setting the shininess of the shape.

quit

This class is a subclass of the ConsoleCommand class and is a ConsoleCommand to exit the shared environment.

RegisterCommandReceiver

This class is a subclass of the Command class and provides a Command to register a CommandReceiver object with the Kernel.

RegisterRegistrationListener

This class is a subclass of the Command class and provides a Command to register a RegistrationListener object with the Kernel.

RegistrationListener

This interface manages registration events in the distributed system. Methods are called by the Kernel to register and unregister a CommandReceiver object. Whenever a CommandReceiver is registered with the Kernel, all RegistrationListeners are called. The primary function of a RegistrationListener is to establish links between specific types of Pawns. However, a RegistrationListener can also be used for other functions, such as providing periodic functions such as collision detection or animation.

ReleaseCmd

This class is a subclass of the Command class and provides a Command to release a Pawn.

Renderable

This interface is an abstract interface flagging objects that are renderable by a Construct.

ReqState

This class implements the serializable interface. It provides a method to return a Pawn ID.

RotateCmd

This class is a subclass of the TransformCmd class and provides a Command to rotate a Pawn.

saveoutput

This class is a subclass of the ConsoleCommand class and is a ConsoleCommand to save output written to the Console to a specified file

ScaleCmd

This class is a subclass of the TransformCmd class and provides a Command to scale a Pawn.

setenv

This class is a subclass of the ConsoleCommand class and is a ConsoleCommand to set or display the value of an environment variable.

SetEnvironmentVariableCmd

This class is a subclass of the Command class and provides a Command to set an environment variable.

SocketWrapper

This class holds a TCP/IP socket and its output stream for sending objects. Methods are provided to send an object to other Nengines, get an IP address or socket number, and destroy the socket.

SpaceOrb

This class is a subclass of the ControlDevice class and implements the ConfigUser and Runnable interfaces. This ControlDevice supports a SpaceOrb, a six degrees of freedom (6D) motion control device now marketed under the name SpaceBall by Labtec, Inc., providing methods and variables needed to configure and respond to movement of the SpaceOrb device.

Sphere

This class is a subclass of the Primitive class and provides a spherical Pawn of a specified size.

Splash

This class is a subclass of the JAVA JWindow class. It loads and displays a logo or other image upon initialization.

State

This class implements the Networkable interface. State objects hold attributes for a Pawn.

StateUpdater

This class is a subclass of the standard JAVA Thread class. The State object will inform all Shadows of a Pawn of any changes in attributes of the Pawn caused by execution of a Command.

State Wrapper

This class implements the Networkable interface. StateWrapper objects hold variable for a Pawn and its State.

StdNode

This class is a subclass of the NetNode class and provides the Node described above. A StdNode is an abstract network representation of a Pawn for the NetworkEngine. Methods process Commands received by a Shadow, sending the command to the Pawn, and Commands received by a Pawn, which are processed by the Pawn.

StereoConstruct

This class is a subclass of the Construct class. StereoConstruct objects are Constructs for display on an Immersadesk from Fakespace, Inc.

TCPListener

This class is a subclass of the Thread class. The TCPListener holds a TCP/IP port with a specific computer, through which messages are sent. The TCPListener must take generic incoming objects and send them to an intermediate class that will interpret the incoming object then send the object to the appropriate place in the Nengine.

TextConsole

This class is a subclass of the Console class. It provides a text-based console. Class variables define the width, height, rows, and columns of the console. Keystrokes from a Keyboard are passed to the TextConsole.

TimerCmd

This class is a subclass of the Command class and implements a Command to obtain the time duration since the previous issuance of a TimerCmd.

TimerCmdGenerator

This class is a subclass of the standard JAVA Thread class and creates a timer that sends a Pawn a TimerCmd on a periodic basis.

TransformCmd

This class is a subclass of the Command class and implements a Command to transform a Pawn.

TransformState

This class is a subclass of the State class and provides an object for holding translation, rotation, and scaling data.

TranslateCmd

This class is a subclass of the TransformCmd and provides a Command to move a Pawn.

UDPListener

This class is a subclass of the standard JAVA Thread class and listens to the UDP port established by the Nengine. The UDPListener must take generic incoming objects and send them to an intermediate class that will interpret the incoming object then send the object to the appropriate place in the Nengine.

UnregisterCommandReceiver

This class is a subclass of the Command class and implements a Command to unregister a CommandReceiver object with the Kernel.

The above description of classes and interfaces is illustrative and exemplary only, and other classes, interfaces, class and interface hierarchies, methods, and variables can be used. In addition, although the above classes and interfaces are written in the JAVA language, other extensible object-oriented programming languages could be used.

Emergent Behavior

Emergent behavior, simply defined, is when a system seems to act in a more organized fashion than its individual parts are capable of. Polish-born mathematician W. Daniel Hillis, writing in the 1930s, used water as an example. A molecule of water is two hydrogen atoms and one oxygen atom. This simple system, on its own, can be found grouped haphazardly with other molecules. But at cold temperatures, molecules of water vapor group themselves into geometric structures: snowflakes. Something in water's molecular “programming” causes it to behave this way, though no one could determine that just from looking at a single water molecule. In other words, complex physical systems are the sum product of small constituent objects, each of which has a simple rule set.

Today, “emergent behavior” is often used to describe computer systems grown so complex they exhibit capabilities not programmed by the software developer or hardware designer. Hillis predicted that if a complex set of “artificial neurons”—microprocessors, in today's language—was created and made significantly large, it could theoretically begin to display emergent behavior: it could begin not only to display unpredictable behavior, but also to “think.” In object-oriented programming, complex

The shared environment 100 and the distributed system S allow the creation of applications quickly and easily. Rather than writing long programs, disclosed embodiments allows the use of autonomous and self-contained small Pawns, interacting through Commands, Behaviors, and simple rule sets (the Command-Behavior mappings), in a way which can create a powerful distributed system S which exhibits emergent behavior.

### EXAMPLES

In one example, an Integrated Parallel Accurate Reservoir Simulator (IPARS) visualization tool for a volume rendering application was created in three days. The volume rendering application reused existing graphical display and avatar components, an IPARS data loader and a volume rendering Pawn.

In a second example, a submarine simulator was developed in approximately two days using Pawns for the submarine, its radar, mines, and submarine controls, combined with an existing graphics display. A user of the submarine simulator drives Submarine Pawns. Submarines have the ability to move and rotate in the shared environment. When given a certain velocity via a Velocity Command, a Submarine follows its current direction until steered otherwise or until the Submarine collides with a Mine. When given a change of direction via a ChangeDirection Command, the Submarine changes its heading. ControlDevices were written to allow the user to steer the Submarine, with Behaviors that sent Commands such as ChangeDirection and Velocity to the Submarine. Mine Pawns were created to blow up the Submarine if the Submarine collided with the Mine. Mines do not do anything except take up space and explode when hit. The Submarine driver would attempt to drive the Submarine toward a Target Pawn. The Target Pawn was essentially a Mine, which the Submarine knows it can hit and not blow up. The Submarine uses a Radar Pawn, which is a subPawn of the submarine Pawn that detects the Mine Pawns and returns its information for rendering on a display. Much of the game play depends on the Radar. Once a second, the Radar scans the area in front of it up to a specified distance. This is kept as an N×N array, where N is the number of scan lines on the display. The Radar also checks to see it is at distance=0 from a Mine, in which case the Submarine on which the Radar is located blows up. The Radar also checks to see if the Submarine is at distance=0 from the Target, in which case it stops the game and notifies the user that the user has won the game.

Applications designed entirely independent of each other can be used together in the same shared environment 100. In a hypothetical example, two popular games such as SimCity™, from Maxis, Inc., and Quake, from id Software, Inc. could be independently developed using the disclosed distributed system. Even though each game was independently developed, with no intent to be played with each other, the distributed system as disclosed would allow SimCity objects to talk to Quake objects with very little effort, creating a whole new game where people play Capture the Flag or Deathmatch (Quake activities) in a city that is being actively and continually modified and altered by a user playing SimCity.

### SUMMARY

Briefly, a system for manipulating computer-implemented objects in a distributed system provides software for creating a shared environment of multiple objects. Each of the objects in the shared environment has a number of Behaviors, executing Behaviors responsive to a Command. A Command-Behavior mapping is used to map Commands received by the object to Behaviors, executing a selected Behavior responsive to the Command. A default Behavior is executed if no Behavior is mapped to the Command. The software provides code to modify the Command-Behavior mapping of an object. The Command-Behavior mapping can be created from an external data source.

All of the attributes of an object are self-contained within the object. This allows relatively easy programming of autonomous objects, allowing the distributed system to exhibit Emergent Behavior.

Shadows of the object, which are synchronized with the object, are created in the distributed system. The Shadows can have a different Command-Behavior mapping from the object. All the Shadows of an object communicate with each other and the object to synchronize the Shadows and the objects. A Shadow can be promoted into a new object, which may convert the other Shadows of the original object into Shadows of the new object.

The distributed system can reside on multiple servers. In a multiple server embodiment, the object is located on one of the servers, and acts independently of its location. The software can use any available networking protocol to communicate between objects.

The distributed system allows application designers to create applications with hardware independence and transparent networking, allowing relatively fast application development and enhancing the ability to reuse objects written for one application in another application. Further, applications can be designed with little or no thought given to networking, and yet be fully collaborative when run in a distributed system with different operating systems, display geometries, and graphical libraries.

Further, applications designed entirely independent of each other can be used together in the same environment. This interoperability creates the potential for a universe of interoperable games, content, and collaborative applications.

The foregoing disclosure and description of the various embodiments are illustrative and exemplary thereof, and various changes in the elements, programming techniques, and connections, as well as in the details of the illustrated objects and method of operation may be made without departing from the spirit of the invention.

1. A storage medium containing software for manipulating computer-implemented objects in a distributed system, the software comprising:
code to create a shared environment, the shared environment comprising a plurality of objects; and
code to create an object, the object exposed to other objects in the shared environment, the object comprising:
a set of Behavior logics, each member of the set of Behavior logics adapted to cause the object to perform a task; and
a first Behavior logic, adapted to receive a Command from another object in the shared environment, the first Behavior logic invokable external to the object, the first Behavior logic comprising:
code to receive the Command;
code to select a Behavior logic of the set of Behavior logics corresponding to the Command from a Command-Behavior mapping; and
code to execute the selected Behavior logic responsive to the Command.

2. The storage medium of claim 1, the set of Behavior logics and the Command-Behavior mapping private to the object.

3. The storage medium of claim 1, the set of Behavior logics having no members.

4. The storage medium of claim 1, the object further comprising:
a default Behavior logic, adapted to cause the object to perform a default task, the default Behavior logic private to the object; the first Behavior logic further comprising:
code to execute the default Behavior logic responsive to the Command if no Behavior logic is selected by the code to select a Behavior logic corresponding to the Command.

5. The storage medium of claim 1, wherein the Command-Behavior mapping can cause the code to select a Behavior to select multiple Behaviors.

6. The storage medium of claim 1, the object further comprising:
an authentication data, the authentication data providable to other objects for authenticating Commands received from the other objects by the code to receive the Command.

7. The storage medium of claim 6, wherein the Command comprises the authentication data, the Command-Behavior mapping restrictable responsive to the authentication data.

8. The storage medium of claim 1, the software further comprising:
code to create a first Shadow of the object, the first Shadow of the object adapted to communicate with the object, the first Shadow of the object being informed of changes to the object and the object being informed of changes to the first Shadow of the object.

9. The storage medium of claim 8, wherein the first Shadow of the object is a copy of the object.

10. The storage medium of claim 8, wherein the Command-Behavior mapping of the first Shadow of the object differs from the Command-Behavior mapping of the object.

11. The storage medium of claim 8, the software further comprising:
code to create a plurality of Shadows of the object adapted to communicate with the object and the first Shadow of the object, the object and the first Shadow of the object being informed of changes to any of the plurality of Shadows of the object and each of the plurality of Shadows of the object being informed of changes to the object and changes to the first Shadow of the object.

12. The storage medium of claim 8, the software further comprising:
code to promote the first Shadow of the object into a new object.

13. The storage medium of claim 12, the software further comprising:
code to create a plurality of Shadows of the object,
wherein executing the code to promote the first Shadow of the object into a new object converts each of the plurality of Shadows of the object into a Shadow of the new object.

14. The storage medium of claim 12, the shared environment further comprising:
a plurality of servers, the object on a first server of the plurality of servers, the first Shadow of the object on a second server of the plurality of servers; and
code to manage the plurality of servers, executing the code to promote the first Shadow of the object to a new object if the first server experiences a predetermined condition.

15. The storage medium of claim 1, the set of Behavior logics further comprising:
code to modify the Command-Behavior mapping to cause the code to select a Behavior logic responsive to the Command to select a different Behavior logic of the set of Behavior logics.

16. The storage medium of claim 1, the shared environment comprising:
a plurality of servers, the object having a location on one of the plurality of servers, the object acting independent of the location.

17. The storage medium of claim 1, the object further comprising:
code to create the Command-Behavior mapping from an external data source.

18. The storage medium of claim 1, the software capable of using any networking protocol.

19. A method of manipulating a computer-implemented object in a distributed system, the method comprising the steps of:
creating a shared environment; the shared environment comprising a plurality of objects; and
creating an object, the object exposed to other objects in the shared environment, the step of creating an object comprising the step of:
coding a set of Behavior logics, each member of the set of Behavior logics causing the object to perform a task;
manipulating the object, comprising the steps of:
receiving a Command from another object of the plurality of objects in the shared environment;
selecting a Behavior logic of the set of Behavior logics corresponding to the Command from a Command-Behavior mapping; and
executing the selected Behavior logic responsive to the Command.

20. The method of claim 19, wherein the set of Behavior logics and the Command-Behavior mapping are private to the object.

21. The method of claim 19, further comprising the step of:
changing the Command-Behavior mapping, causing the step of selecting a Behavior logic to select a different Behavior logic of the set of Behavior logics responsive to the Command.

22. The method of claim 19, the method further comprising the steps of:
coding a default Behavior logic to cause the object to perform a default task, and
executing the default Behavior logic if no Behavior logic is selected by the step of selecting a Behavior logic.

23. The method of claim 19, the set of Behavior logics having no members.

24. The method of claim 19, wherein the Command-Behavior mapping can cause the step of selecting a Behavior logic to select multiple Behaviors.

25. The method of claim 19, further comprising the steps of:
creating an authentication data for the object.

26. The method of claim 25, the Command comprising the authentication data, the method further comprising the step of:
restricting the Command-Behavior mapping responsive to the authentication data.

27. The method of claim 19, further comprising the step of:
creating a first Shadow of the object, the first Shadow of the object adapted to communicate with the object, the first Shadow of the object being informed of changes to the object and the object being informed of changes to the first Shadow of the object.

28. The method of claim 27, the step of creating the first Shadow of the object comprising the step of:
copying the object.

29. The method of claim 27, the step of creating the first Shadow of the object comprising the step of:
modifying the Command-Behavior logic of the first Shadow of the object.

30. The method of claim 27, further comprising the step of:
creating a plurality of Shadows of the object, adapted to communicate with the object and the first Shadow of the object, the object and the first Shadow of the object being informed of changes to any of the plurality of Shadows of the object and each of the plurality of Shadows of the object being informed of changes to the object and changes to the first Shadow of the object.

31. The method of claim 27, further comprising the step of:
promoting the first Shadow of the object into a new object.

32. The method of claim 31, further comprising the step of:
creating a plurality of Shadows of the object,
converting each of the plurality of Shadows of the object into a Shadow of the new object, responsive to the step of promoting the first Shadow of the object.

33. The method of claim 19, the shared environment comprising:
a plurality of servers;
wherein the object has a location on a first server of the plurality of servers, the object acting independent of the location.

34. The method of claim 19, the shared environment capable of using any networking protocol to communicate with another shared environment.

35. The method of claim 19, further comprising the step of:
creating the Command-Behavior mapping from an external data source.

36. A method of designing an application from configurable objects having Behavior logics capable of performing tasks, the method comprising the steps of:
creating a plurality of objects, each object of the plurality of objects adapted to receive and execute Commands, each object exposed to each other object of the plurality of objects, the step of creating the plurality of objects comprising the steps of:
creating a set of Behavior logics for an object, the set of Behavior logics capable of being an empty set;
mapping members of a first set of Commands to members of the set of Behavior logics;
mapping any Command not a member of the first set of Commands to a default Behavior logic; and
configuring a Command-receiver Behavior logic to receive a Command and execute the Behavior logic corresponding to the Command.

37. The method of claim 36, further comprising the steps of:
creating a Shadow of an object of the plurality of objects, the Shadow configured such that sending a Command to the Shadow causes the object to act as if the Command had been sent to the object.

38. The method of claim 37, each of the plurality of objects having a location on one of a plurality of servers, each of the plurality of objects being independent of the location of each other of the plurality of objects.

39. The method of claim 38, a Shadow of each of the plurality of objects automatically created on each of the plurality of servers other than the server on which the object is located.

40. A processor-based system, comprising:
a first processor; and
a first storage device coupled to the first processor containing a software to manipulate computer-implemented objects in a shared environment, the software comprising:
code to create a shared environment, the shared environment comprising a plurality of objects; and
code to create an object of the plurality of objects, the object exposed to other objects in the shared environment, the object comprising:
a set of Behavior logics, each member of the set of Behavior logics adapted to cause the object to perform a task; and
a first Behavior logic, adapted to receive a Command from another object in the shared environment, the first Behavior logic invokable external to the object, the first Behavior logic comprising:
code to receive the Command;
code to select a Behavior logic of the set of Behavior logics corresponding to the Command from a Command-Behavior mapping; and
code to execute the selected Behavior logic responsive to the Command.

41. The processor-based system of claim 40, the object further comprising:
a default Behavior logic, adapted to cause the object to perform a default task, the default Behavior logic private to the object; the first Behavior logic further comprising:
code to execute the default Behavior logic responsive to the Command if no Behavior logic is selected by the code to select a Behavior logic corresponding to the Command.

42. The processor-based system of claim 40, wherein the Command-Behavior mapping can cause the code to select a Behavior logic to select multiple Behaviors.

43. The processor-based system of claim 40, further comprising:
an input device coupled to the first processor,
wherein a first object of the plurality of objects is coupled to the input device such that manipulation of the input device sends a Command from the first object to a second object of the plurality of objects without identifying the input device, the second object of the plurality of objects acting responsive to the Command independent of the nature of the input device.

44. The processor-based system of claim 40, further comprising:
an output device coupled to the first processor,
wherein a first object of the plurality of objects is coupled to the input device such that a first object is capable of rendering a second object on the output device without identifying the output device to the second object.

45. The processor-based system of claim 40, further comprising:
a second processor;
a network, coupled to the first processor and the second processor;
a second storage device coupled to the second processor, the second storage device containing the software;
the software further comprising:
code to connect the shared environment to the network;
code to create a Shadow on the second processor of the object on the first processor, the Shadow and the object communicating with each other to inform the Shadow of changes to the object and the object of changes to the Shadow.

46. A software architecture for manipulating computer-implemented objects on a plurality of computers, some of the plurality of computers having input devices and some of the plurality of computers having output devices, the software architecture implemented in an extensible object-oriented language, comprising:
a distributed system, comprising:
a plurality of shared environments, each of the plurality of shared environments executing on a different computer of the plurality of computers, each of the plurality of shared environments comprising:
a CommandReceiver class, the CommandReceiver class comprising:
a set of Behavior private methods, each member of the set of Behavior methods adapted to cause instantiations of the CommandReceiver class to perform a task; and
an executeCommand public method, adapted to receive a Command from an object in the shared environment, the executeCommand public method comprising:
code to receive the Command;
code to select a Behavior private method of the set of Behavior private methods selected corresponding to the Command from a Command-Behavior mapping; and
code to execute the selected Behavior private method; and
a Kernel subclass of the CommandReceiver class, the Kernel class comprising:
code to instantiate objects of the CommandReceiver class;
code to destroy objects of the CommandReceiver class.

47. The software architecture of claim 46, further comprising:
a Pawn subclass of the CommandReceiver class, the Pawn subclass comprising:
code to register an instantiation of a Pawn with a Kernel object of the Kernel subclass;
code to determine whether an instantion of the Pawn subclass is a real Pawn or a Shadow Pawn of a real Pawn, and
code to send State information about an instantiation of the Pawn subclass,
wherein Commands received by Shadow Pawns are sent to the real Pawn corresponding to the Shadow Pawn.

48. The software architecture of claim 46, further comprising:
a ControlDevice subclass of the CommandReceiver class corresponding to an input device for receiving input from the input device and sending Commands to other CommandReceiver objects.

49. The software architecture of claim 46, further comprising:
a Construct subclass of the CommandReceiver class corresponding to an output device for rendering objects of the CommandReceiver class with graphical attributes.

50. The software architecture of claim 46, further comprising:
a Console subclass of the CommandReceiver class for allowing a user of the distributed system to instantiate, modify, and destroy objects, and for allowing a user to send Commands to CommandReceiver objects.

51. The software architecture of claim 46, further comprising:
a Nengine subclass of the CommandReceiver class for serializing and deserializing CommandReceiver objects, transmitting and receiving the serialized CommandReceiver object across a network to a Nengine in another shared environment of the distributed system.

52. The software architecture of claim 51, further comprising:
a Node subclass of the CommandReceiver class, an instantiation of the Node subclass corresponding to a Pawn object for representing the Pawn object to a Nengine object for communicating State information corresponding to a Pawn to Shadow Pawns of the Pawn and for communicating Commands sent to a Shadow Pawn to the real Pawn corresponding to the Shadow Pawn.
